(19) United States
(12) Patent Application Publication
(10) Pub. No.: US 2010/0096363 A1
(43) Pub. Date: Apr. 22, 2010

(54) SWITCHING CHAMBER FOR A HIGH-VOLTAGE BREAKER, AND A HIGH-VOLTAGE BREAKER

(75) Inventors: Xiangyang YE, Taipei County (TW); Nicola Gariboldi, Nussbaumen (CH)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/582,344

(22) Filed: Oct. 20, 2009

(30) Foreign Application Priority Data
Oct. 22, 2008 (EP) 08167209.9

(51) Int. Cl. H01H 33/02

(52) U.S. Cl. 218/157

(57) ABSTRACT

A circuit breaker and a switching chamber are disclosed which include a switching chamber housing composed of electrically conductive material, which surrounds an erosion volume and has an axially directed outlet which connects the erosion volume to an outlet opening on the outer face of the switching chamber housing, or which has at least one radially directed outlet. The outlet can include an insert, which is located in an aperture in the switching chamber housing and which is composed of electrically insulating material. A connecting stub surrounds an outlet channel and projects beyond the outer face of the switching chamber housing. A collar projects outward and rests on the inner face of the switching chamber housing. The aperture is located in a depression on the outer face of the switching chamber housing, such that the triple point where the switching chamber housing meets the insert is shielded. The outlet channel can carry heated insulating gas flowing out away from areas where there is an increased electrical field strength adjacent to the rim of the depression.

### RELATED APPLICATIONS

This application claims priority under 35 U.S.C. §119 to European Patent Application No. 08167209 9 filed in Europe on Oct. 22, 2008, the entire content of which is hereby incorporated by reference in its entirety.

### FIELD

The disclosure relates to a high-voltage breaker and to a switching chamber for a high-voltage breaker which can, for example, be used in power distribution installations.

### BACKGROUND INFORMATION

A switching chamber is known from EP 1 835 520 A1. On disconnection, insulating gas in the switching chamber is heated to a major extent by the arc which is struck between the erosion contacts, thus producing an increased pressure. The hot insulating gas is fed through outlets from the switching chamber housing and into an expansion area which surrounds the switching chamber and is surrounded by an encapsulation of a high-voltage breaker. The electrical field strengths are locally increased adjacent to the rims and in the areas surrounding the outlets, because of the greater curvatures on the outer face of the switching chamber housing. In addition, the dielectric strength in this area is reduced because of the flow of hot insulating gas. These are areas in which, very probably, there is a risk of flashovers between the switching chamber housing and the grounded encapsulation that surrounds it at a distance, thus essentially determining the dimensions of the latter.

### SUMMARY

A switching chamber is disclosed for a circuit breaker, comprising: a switching chamber housing composed of electrically conductive material, which surrounds an erosion volume; an erosion contact arrangement arranged in the erosion volume; and at least one outlet which connects the erosion volume to an outlet opening on an outer face of the switching chamber housing, wherein at least an area directly surrounding the outlet opening is formed by electrically insulating material.

A high-voltage breaker is disclosed comprising: a switching chamber housing composed of electrically conductive material, which surrounds an erosion volume; an erosion contact arrangement arranged in the erosion volume; at least one outlet which connects the erosion volume to an outlet opening on an outer face of the switching chamber housing, wherein at least an area directly surrounding the outlet opening is formed by electrically insulating material; and an encapsulation which is filled with insulating gas and is composed of electrically conductive material, which surrounds the switching chamber housing at a distance and is electrically isolated therefrom to form a high-voltage breaker.

### BRIEF DESCRIPTION OF THE DRAWINGS

The disclosure will be explained in more detail in the following text with reference to figures which illustrate exemplary embodiments, and in which:

FIG. 1 shows, schematically, an axial longitudinal section through a part of a first exemplary embodiment of a high-voltage breaker with a switching chamber; and

FIG. 2 shows, schematically, an axial longitudinal section through a part of a second exemplary embodiment of a high-voltage breaker having a switching chamber.

### DETAILED DESCRIPTION

Exemplary embodiments of a switching chamber as disclosed herein can impact (e.g., improve) breakdown strength in an outlet area.

A switching chamber as disclosed herein can result in stronger electrical fields not being directly adjacent to rims of outlet openings of the switching chamber. The flow of hot insulating gas there can touch only electrically insulating material. In contrast, it can be kept away from the electrically conductive outer face of the switching chamber housing in the area surrounding an outlet opening. The connection between strong electrical fields and strong flows of heated insulating gas, which otherwise occurs adjacent to the rim of the outlet can thereby be avoided. The encapsulation for the high-voltage breaker may have correspondingly smaller dimensions, and can thus be kept more compact and can be produced at lower cost.

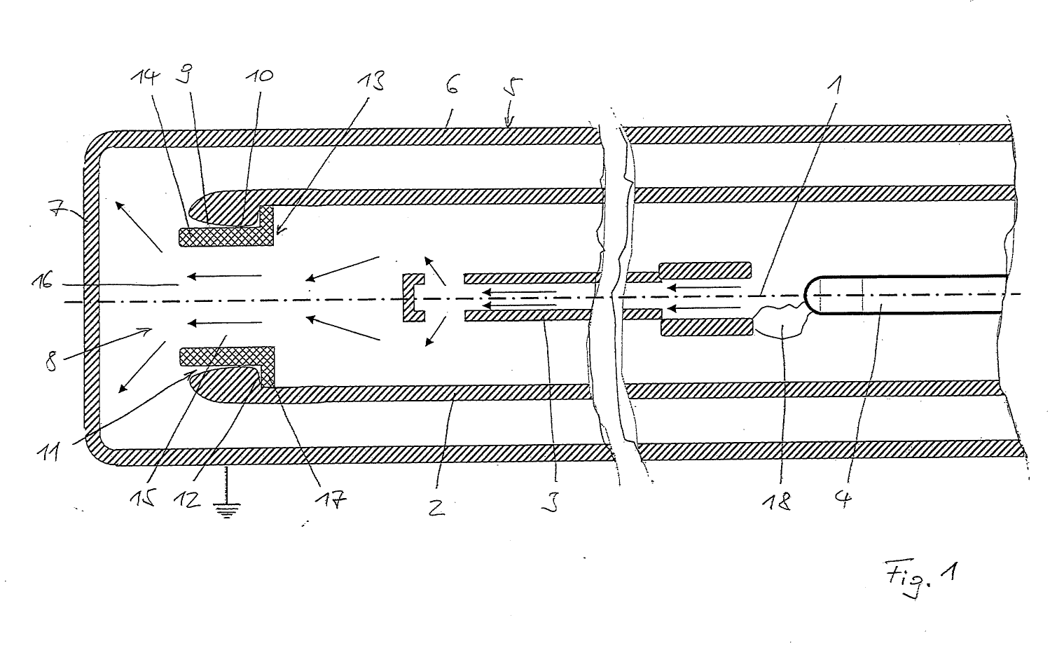

A circuit breaker, such as a high-voltage breaker which is illustrated in FIG. 1 and is essentially rotationally symmetrical about an axis 1, has a first exemplary embodiment of a switching chamber which includes an approximately tubular switching chamber housing 2 composed of electrically conductive material, for example, a metal such as aluminum or steel, which surrounds an erosion volume which is filled with an insulating gas, for example SF₆. The switching chamber housing 2 can be firmly connected to a contact tube 3 which, together with a contact pin 4 in the erosion volume, forms an erosion contact arrangement which is coaxial with the switching chamber housing 2. The switching chamber housing 2 can be arranged such that it can move axially in cylindrical encapsulation 5 composed of electrically conductive material, for example, a metal such as aluminum or steel, from which it is electrically isolated. The grounded, closed encapsulation 5 has a tubular side wall 6 which coaxially surrounds the switching chamber housing 2 at a distance, as well as an end wall 7 which closes it. An expansion area, which is likewise surrounded by the encapsulation 5 and surrounds the switching chamber housing 2, can be likewise filled with insulating gas.

An outlet 8 which runs in the axial direction and is rotationally symmetrical around the axis 1 is provided in the switching chamber housing 2 at the end facing away from the contact pin 4. There, the switching chamber housing 2 is essentially (i.e., substantially) open, having an aperture 9 whose rim 10—its narrowest point—can be overhung by an end section thereof. The rim 10 is thus recessed with respect to the surrounding part of the outer face of the switching chamber housing 2, and located in a depression 11 whose rim line has a convex radial cross section. Within the rim 10, the aperture 9 widens again, virtually in the form of a step, as a result of which the switching chamber housing 2 forms a circumferential step 12 there.

An insert 13 is located in the aperture 9, and is composed of an electrically insulating material, for example of a heat-resistant plastic such as Teflon® or of ceramic. This insert 13 has a connecting stub 14 which surrounds an axially directed outlet channel 15, which connects the erosion volume to an outlet opening 16, which is opposite the end wall 7. In the area of the rim 10 of the aperture 9, it is touched by the switching chamber housing 2, while it is at a distance therefrom further outward, since the depression 11 widens there. It projects somewhat beyond that area of the outer face of the switching chamber housing 2 which surrounds the depression 11, that is to say the end thereof opposite the end wall 7. A circumferential collar 17 which projects outward is connected to the inner end of the connecting stub 14, rests on the inner face of the switching chamber housing 2 in the area of the step 12, and fixes the insert 13.

As a result of the end area of the switching chamber housing 2 being designed with the depression 11, which narrows to the rim 10 of the aperture 9, and the subsequent widening of the aperture 9 as far as the step 12, this forms a convex circumferential bead, which projects inward, at the end. The curvature of the outer face of the switching chamber housing 2 is at its greatest in the area of the end of the latter, and the electrical field strength therefore can reach the highest values there. The contact line between the electrically conductive switching chamber housing 2 and the electrically insulating insert 13—the so-called triple point—can in contrast be located relatively deep in the depression 11, and be electrically shielded by the projecting end of the switching chamber housing 2, as a result of which the electrical field strengths there are low.

The insulating gas in the erosion volume can be heated by an arc 18 which is struck between the contact tube 3 and the contact piece 4 when they are disconnected, as a result of which there is a marked increase in pressure there. This causes a gas flow in the axial direction, partially through the contact tube 3, and through the outlet channel 15 into the expansion area which is surrounded by the encapsulation 5. The gas flow can pass through the connecting stub 14, which projects somewhat beyond the outer face of the switching chamber housing 2, such that it is kept away from the end of the switching chamber housing 2 where the greatest electrical fields strengths occur. It flows against the end wall 7 of the encapsulation 5, where it can be deflected outward into the annular area located between its end wall 6 and the switching chamber housing 2.

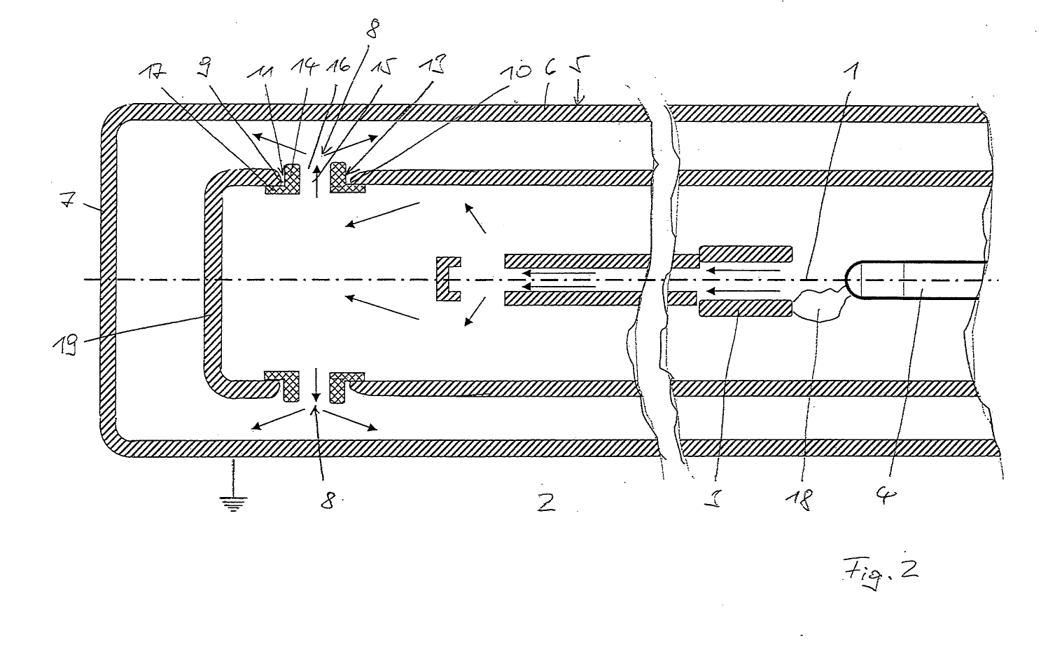

The high-voltage breaker illustrated in FIG. 2 has a second exemplary embodiment of a switching chamber, although this largely corresponds to that of the first embodiment. Other parts of the high-voltage breaker correspond completely to those of the breaker illustrated in FIG. 1.

In this case, however, the switching chamber housing 2 is closed at the end by an end wall 19, and has a plurality of outlets 8, for example four or six outlets which can be arranged slightly in front thereof, distributed uniformly over the circumference, and directed radially outward and are smaller. Apart from this, components of the switching chamber are similar to those in the first embodiment. In this case as well, the aperture 9 is in each case arranged recessed in a depression 11, whose rim line has a convex radial cross section, that is to say its rim 10 which denotes its narrowest point, is recessed with respect to the outer face of the switching chamber housing 2. The connecting stub 14 of the insert 13 located in the aperture 9 in turn projects somewhat beyond the outer face of the switching chamber housing 2. Its diameter is smaller than that of the aperture 9, as a result of which it is at some distance from the rim 10 thereof, all the way round. The switching chamber can be configured such that, for example, only the collar 17 touches the switching chamber housing 2, on the inside of the collar 17, as a result of which the triple point is in this case located at the inner end of the aperture 9, that is to say once again in a shielded area, which is at a distance from the rim of the depression 11, where the electrical field strength is at its highest, with the electrical field strengths in this shielded area being considerably less.

The gas flow which occurs on disconnection can pass through the outlet channels 15, which are directed radially outward, against the side wall 6 of the encapsulation 5, and be reliably kept away from the area surrounding the aperture 9, where the electrical field strengths are higher.

Instead of there being a plurality of radial outlets, it is also possible to provide one circumferential radial outlet in the form of an annular gap.

Further embodiments are possible which differ from those described above, and which make use of the idea according to the disclosure. For example, the switching chamber housing may also be connected to the stationary contact piece and may have outlets in the area of the opposite end. Axial and radial outlets can also be combined.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 Axis
2 Switching chamber housing
3 Contact tube
4 Contact pin
5 Encapsulation
6 Side wall
7 End wall
8 Outlet
9 Aperture
10 Rim
11 Depression
12 Step
13 Insert
14 Connecting stub
15 Outlet channel
16 Outlet opening
17 Collar
18 Arc
19 End wall

What is claimed is:

1. A switching chamber for a circuit breaker, comprising:
a switching chamber housing composed of electrically conductive material, which surrounds an erosion volume;
an erosion contact arrangement arranged in the erosion volume; and
at least one outlet which connects the erosion volume to an outlet opening on an outer face of the switching chamber housing, wherein at least an area directly surrounding the outlet opening is formed by electrically insulating material.

2. The switching chamber as claimed in claim 1, wherein a part of the electrically insulating material which surrounds the outlet opening projects beyond the outer face of the switching chamber housing.

3. The switching chamber as claimed in claim 1, wherein the electrically insulating material is an insert which is inserted into an aperture in the switching chamber housing and surrounds an outlet channel which leads to the outlet opening.

4. The switching chamber as claimed in claim 3, wherein the insert comprises:
a connecting stub, which surrounds the outlet channel and overhangs an area, surrounding the aperture, on the outer face of the switching chamber housing.

5. The switching chamber as claimed in claim 3, wherein the aperture is located in a depression on the outer face of the switching chamber housing, such that a rim of the aperture is recessed with respect to an area of the outer face of the switching chamber housing which surrounds the depression.

6. The switching chamber as claimed in claim 5, wherein the rim of the aperture touches the connecting stub in an area which is recessed with respect to the outlet opening, while parts of the connecting stub which are located further outward are at a distance from the switching chamber housing.

7. The switching chamber as claimed in claim 3, wherein the insert comprises:
a collar which projects outward from the outlet channel and rests on an inner face of the switching chamber housing.

8. The switching chamber as claimed in claim 4, wherein the connecting stub is at a distance from the switching chamber housing.

9. The switching chamber as claimed in claim 1, wherein the switching chamber housing is essentially rotationally symmetrical about an axis.

10. The switching chamber as claimed in claim 9, wherein the switching chamber housing has an axially directed outlet at one end.

11. The switching chamber as claimed in claim 9, wherein the switching chamber housing has at least one radially directed outlet.

12. The switching chamber as claimed in claim 1, wherein the electrically insulating material is plastic or ceramic.

13. A switching chamber as claimed in claim 1, in combination with encapsulation which is filled with insulating gas and is composed of electrically conductive material, which surrounds the switching chamber housing at a distance and is electrically isolated therefrom to form a high-voltage breaker.

14. The switching chamber as claimed in claim 4, wherein the aperture is located in a depression on the outer face of the switching chamber housing, such that a rim of the aperture is recessed with respect to an area of the outer face of the switching chamber housing which surrounds the depression.

15. The switching chamber as claimed in claim 14, wherein the insert comprises:
a collar which projects outward from the outlet channel and rests on an inner face of the switching chamber housing.

16. The switching chamber as claimed in claim 15, wherein the connecting stub is at a distance from the switching chamber housing.

17. The switching chamber as claimed in claim 16, wherein the switching chamber housing is essentially rotationally symmetrical about an axis.

18. The switching chamber as claimed in claim 17, wherein the electrically insulating material is plastic or ceramic.

19. A high-voltage breaker comprising:
a switching chamber housing composed of electrically conductive material, which surrounds an erosion volume;
an erosion contact arrangement arranged in the erosion volume;
at least one outlet which connects the erosion volume to an outlet opening on an outer face of the switching chamber housing, wherein at least an area directly surrounding the outlet opening is formed by electrically insulating material; and
an encapsulation which is filled with insulating gas and is composed of electrically conductive material, which surrounds the switching chamber housing at a distance and is electrically isolated therefrom to form a high-voltage breaker.
